(19) United States
(12) Patent Application Publication
(10) Pub. No.: US 2026/0054238 A1
(43) Pub. Date: Feb. 26, 2026

(54) MONITORING SYSTEM FOR A POLYMER BLENDING ASSEMBLY

(71) Applicant: PfP Industries, LLC, Houston, TX (US)

(72) Inventors: Brian James Keola DECAIRES, Cypress, TX (US); Christopher Eric DILLEY, Fulshear, TX (US)

(73) Assignee: PfP Industries, LLC, Houston, TX (US)

(21) Appl. No.: 18/812,692

(22) Filed: Aug. 22, 2024

(51) Int. Cl. B01F 35/214; B01F 23/00; B01F 25/314; B01F 35/21; B01F 35/22

(52) U.S. Cl. CPC B01F 35/214; B01F 23/061; B01F 25/314; B01F 35/2111; B01F 35/2201

(57) ABSTRACT

A system for blending fluids includes a hopper that contains an additive, a first flow path extending from the hopper and operable to receive the additive from the hopper and convey the additive along a length of the first flow path, a second flow path in fluid communication with the first flow path to receive the additive from the first flow path, a mixing unit in fluid communication with the second flow path to receive the additive from the second flow path, a monitoring device arranged within the second flow path and operable to capture information based on a flow of the additive within the second flow path, and a controller electronically coupled to the monitoring device and operable to process the captured information and output the information to a console screen.

### BACKGROUND

In the oil and gas industry, hydrocarbons are obtained from subterranean geologic formations by drilling a well that penetrates one or more hydrocarbon-bearing formations. The well provides a flowpath for the hydrocarbons to reach the surface, and production of the hydrocarbons to the surface occurs when a sufficiently unimpeded flowpath from the hydrocarbon-bearing formation to the wellbore is present.

The majority of subterranean formations produced today have low natural permeability, and to improve permeability and well productivity, hydrocarbon-bearing formations are commonly subjected to hydraulic fracturing commonly referred to as “fracking.” Hydraulic fracturing entails pumping a fracturing fluid downhole under high pressure and high flow rates and injecting the fracturing fluid into adjacent hydrocarbon-bearing formations to create, open, and extend formation fractures. Fracturing fluids usually contain propping agents, commonly referred to as “proppant” or “proppant particulates,” that are carried into the fractures and deposited to hold or “prop” open the fractures once the fluid pressure is reduced. Propping the fractures open enhances permeability by allowing the fractures to serve as conduits for hydrocarbons trapped within the formation to flow to the wellbore.

Most fracturing fluids contain one or more additives to viscosify the fracturing fluid and thereby aid in transporting the fracturing fluid and proppant deeper into the fractures. Common viscosifying additives include hydrophilic polymers and guar. Preferred viscosity levels for the fracturing fluids are reached when the viscosifying additive becomes properly hydrated. The term “hydration” refers to the process wherein a hydratable material solvates or absorbs water (hydrates) and swells in the presence of water. Most commonly, a viscosifying additive is added to a fracturing fluid from a non-hydrated or poorly hydrated concentrate. High-shear blending protocols may provide more effective polymer hydration but result in polymer chain scission, which reduces the viscosity of the fluid and compromises the ability of the polymer to transport the proppant. Further, in most instances, conventional fracturing fluid formulation processes do not result in instantaneous hydration, thereby necessitating a wait time or multistage hydration protocol. Moreover, high-shear mixing (blending) may or may not cause a reduction in viscosity but it will damage the structure of the polymer, which can translate to a reduced ability to transport proppant.

As an alternative to waiting, slower hydrating polymers (e.g., guar gum) and faster hydrating polyacrylamides do not go through a pre-hydration step but rather are expected to hydrate “on the fly” as they are pumped. These polymers complete their hydration either in the transport tubulars or early in the fracture. This approach currently is necessary to save time and labor but may not result in obtaining maximum performance properties out of the polymer and the concentration that is being utilized.

Multistage hydration protocols used to generate high viscosity fracturing fluids can be challenging, particularly at remote sites or when large fluid and proppant volumes are required. Special equipment for mixing the dry additives with water is required, and problems such as chemical dusting, uneven mixing, and lumping can often result. Lumping occurs when the initial contact of the dry additive with the water results in rapid hydration of the outer layer of the material, which creates a sticky, rubbery exterior layer that prevents the interior portions of the material from contacting the water. The result is the formation of “gel balls” or “fish eyes,” which can encumber efficiency by lowering the viscosity achieved per pound of dry additive and also by creating insoluble particles that can restrict flow both into and out of the subterranean formations. Consequently, merely mixing the dry additive directly with water often does not generate a homogeneous fracturing fluid, which is one reason why liquid forms of the polymers (e.g., concentrates) are preferred.

Thus, there is still a need in the art for more effective systems and methods for hydrating dry additives used in the production of fracturing fluids, and system and method of monitoring such hydrating systems.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is a schematic diagram of an example blending system in accordance with one or more aspects of the present disclosure.

FIG. 2 is a cross-sectional side view of an example monitoring system implemented in accordance with one or more aspects of the present disclosure.

FIG. 3 is a cross-sectional side view of example portions of the monitoring system implemented in accordance with one or more aspects of the present disclosure.

FIGS. 4 and 5 are example images generated by a camera within the monitoring system implemented in accordance with one or more aspects of the present disclosure.

FIG. 6 is a cross-sectional side view of one example of a mixing unit, according to one or more embodiments.

FIG. 7 is a cross-sectional side view of a nonlimiting embodiment of the extender of FIG. 6.

FIG. 8 is a schematic diagram of an example monitoring system implemented in the monitoring system of FIGS. 2-3.

FIG. 9 is a method flow diagram for performing operations in accordance with one or more aspects of the present disclosure.

FIG. 10 is a block diagram of a computer system that may be used to implement one or more of the systems or methods described herein in accordance with certain aspects.

FIG. 11 is a block diagram of a computer system that may be used to implement one or more of the systems or methods described herein in accordance with certain aspects.

### DETAILED DESCRIPTION

The present disclosure is related to polymer blending systems and, more particularly, to monitoring systems for systems designed for the formulation of various fluid compositions.

The monitoring systems disclosed herein are applicable to monitoring the formulation and combination of working fluids for various industrial applications. Embodiments described herein can be implemented to facilitate advanced quality control for blending systems that are transported to and installed at a work site for incorporation into various fluid circulating systems and blending processes.

The methods disclosed herein are directed to monitoring a blending system in order to more efficiently produce a working fluid by blending one or more additives with a base fluid. Example blending methods may include the combination of a base fluid with various additives and rheological modifiers, such as viscosifiers and friction reducers. Enhanced monitoring of blending systems is advantageous for several reasons, such as facilitating enhanced process control. Target fluid flow rates may be adjusted and optimized quickly, increasing system throughput. The systems described herein provide robust communication of services to end users in real-time.

While the embodiments discussed herein are directed primarily to monitoring the production of working fluids commonly used in the oil and gas industry, those skilled in the art will readily appreciate that the principles disclosed herein are equally applicable to other industries similarly focused on enhanced monitoring of blending base fluids and additives to generate a working fluid. For example, the principles of the present disclosure may alternatively be applied to the production of food, fertilizers, paints, water treatment, and the like.

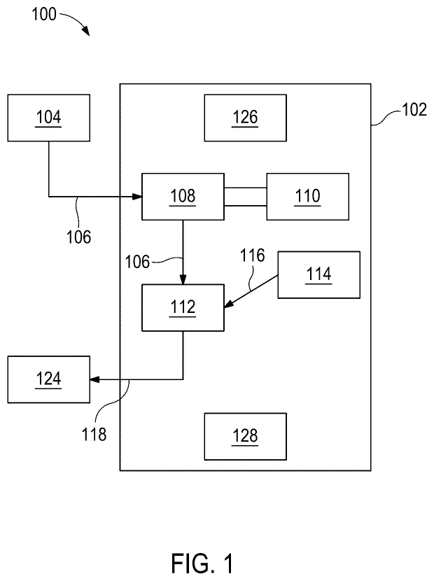

FIG. 1 is a schematic diagram of an example blending system 100 according to one or more aspects of the present disclosure. As illustrated, the blending system 100 (hereafter the “system 100”) may include an enclosure 102 configured to house the various mechanical and electrical equipment, plumbing, tools, etc. required to operate the system 100. In other embodiments, however, the enclosure 102 may be omitted, and the various component parts of the system 100 may be mounted to a skid or on the floor of a warehouse, or the like.

The system 100 may be fluidly coupled to a base fluid source 104 that contains (stores) a base fluid 106. The system 100 may be operable to combine (e.g., mix, blend, etc.) the base fluid 106 with one or more additives to form a working fluid. As used herein, the term “fluidly coupled” refers to a coupled arrangement where a first component is placed in fluid (e.g., liquid, gas, flowable powder, etc.) communication with a second component, such as through suitable plumbing (e.g., pipes, conduits, valving, couplings, etc.). The base fluid source 104 may comprise any suitable type of container or reservoir capable of storing or housing the base fluid 106. Example base fluid sources 104 include, but are not limited to, a tank or container (e.g., an ISO container/tank), a tanker truck, a pipeline, a source of recycled working fluid, a surface reservoir, a subterranean reservoir, or any combination thereof. In at least one embodiment, the base fluid source 104 may comprise a tank or container capable of being hoisted from a horizontal resting position to an upright, vertical position.

The base fluid 106 contained within the base fluid source 104 is not particularly limited, and may vary depending on the application. Example base fluids 106 include, but are not limited to, an aqueous fluid (e.g., fresh water, a brine, a salt solution, etc.), a non-aqueous fluid, a base oil, diesel fuel, an emulsion (e.g., direct and invert emulsions), or any combination thereof.

The system 100 may further include a pump 108, a motor 110 arranged to drive the pump 108, and a mixing unit 112 in fluid communication with the pump 108. As described in more detail below, the mixing unit 112 may include a type of eductor jet configured to help in the blending process.

The pump 108 may comprise any suitable type of pump capable of delivering (pumping) the base fluid 106 to the mixing unit 112 from the base fluid source 104. Examples of the pump 108 include, but are not limited to, a centrifugal pump, a positive displacement pump, a screw pump, and a rotary lobe pump. The pump 108 may be operable to either receive or draw in the base fluid 106 from the base fluid source 104 and provide the base fluid 106 to the mixing unit 112. By way of nonlimiting example, the volumetric flow rate of the base fluid 106 through the mixing unit 112 may be at least about 50 gallons per minute (gpm) (0.19 m³/min), or within a range such as about 50 gpm to about 200 gpm (0.76 m³/min), or about 75 gpm (0.28 m³/min) to about 175 gpm (0.66 m³/min), or about 100 gpm (0.38 m³/min) to about 150 gpm (0.57 m³/min). In some embodiments, the maximum flow rate of the system 100 as a whole may be about 2400 gpm.

The motor 110 used in the system 100 may include various types or configurations capable of suitably powering the pump 108. In some embodiments, the motor 110 may include a totally enclosed fan cooled (TECF), three phase, explosion proof motor capable of outputting 200 hp at 1800 rpm with 480V and 60 Hz. The motor 110 may alternatively be able to output 200 hp at 1800 rmp with 380V and 50 Hz.

The mixing unit 112 may include one or more continuous and/or batch mixing devices, such as an agitator, a mixer, a venturi mixing device, a jet pump, an eductor, an extender, a blender, a static mixer, or any combination thereof.

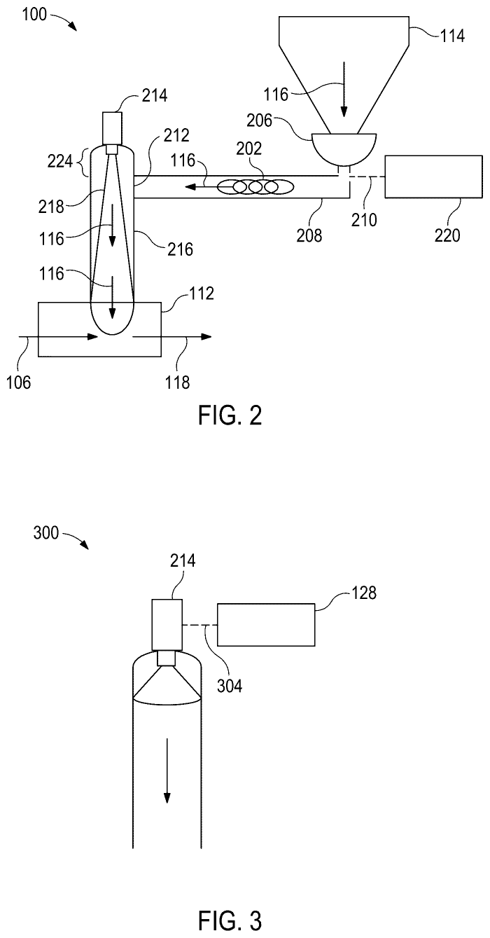

The system 100 further includes a hopper 114 in fluid communication with the mixing unit 112. The hopper 114 is arranged and otherwise configured to deliver one or more additives 116 to the mixing unit 112 to be mixed and/or blended with the base fluid 106. According to embodiments of the present disclosure, a monitoring system (see FIGS. 2-3) may be installed to facilitate real-time monitoring of the delivery of the additives 116 from the hopper 114 to the mixing unit 112. A working fluid 118, alternately referred to as an “extenuated fluid,” is then discharged from the mixing unit 112.

The additive 116 may be in the form of a powder, fine granules, or a liquid (e.g., a concentration, a suspension, an emulsion, a slurry, etc.) and may be fed to the mixing unit 112 by any suitable method such as gravity, vacuum, agitation, vibration, auger, feeder, or any combination thereof. In embodiments where the additive 116 is a powder or fine granules, the additive 116 may be stored under humidity control in which one or more desiccant filters removes ambient moisture to prevent aggregation and caking.

The dosage rate of the additive 116 to the mixing unit 112 may vary depending on the application and depending on what type of working fluid 118 is desired. More specifically, in some embodiments, the rate at which the additive 116 is introduced into the mixing unit 112 may be controlled by volume or weight to accord with a corresponding dosage rate of the base fluid into the mixing unit 112. Control over the dosage rate may be accomplished by any suitable mechanism, including use of a feeder (e.g., an auger, a conveyor, etc.) or a valve operatively coupled to the hopper 114 and otherwise interposing the hopper 114 and the mixing unit 112. The dosage rate may be monitored by the monitoring system described herein with respect to FIGS. 2-4, as described herein.

Following the blending process undertaken in the mixing unit 112, the working fluid 118 may be discharged from the system 100 and conveyed to a downstream location 124. In some embodiments, the downstream location 124 may comprise a storage tank or a transport tank mounted to a vehicle for transport. In other embodiments, the downstream location 124 may comprise subsequent processing for the working fluid 118. In yet other embodiments, the downstream location 124 may comprise an application or operation that directly puts the working fluid 118 to work, such as introducing (injecting) the working fluid 118 downhole to facilitate one or more downhole operations. Example downhole operations include, but are not limited to, drilling, lubrication, hydraulic fracturing (or “fracking”), mitigating downhole fluid loss, and the like. In a hydraulic fracturing operation, the working fluid 118 comprises a hydraulic fracturing fluid that is injected directly downhole or mixed with proppant for use in creating and/or extending at least one fracture in subterranean formations. Alternatively, or in addition thereto, the working fluid 118 may be used as a carrier fluid.

The system 100 also includes suitable plumbing (e.g., pipes, conduits, hoses, etc.) and connectors (couplings) that fluidly couple the various fluid components of the system 100. Moreover, the system 100 may further include one or more valves operable to control fluid flow through the plumbing of the system 100 and between various components parts. Such valves may be manually operated (actuated), or may alternatively be automated. The system 100 may also include various sensors, gauges, and monitoring devices, collectively referred to herein as “sensors 126,” configured to monitor operational parameters of the system 100. Example sensors 126 that may be included in the system 100 include, but are not limited to, a temperature sensor, a pressure sensor (e.g., a vacuum sensor, a differential pressure sensor, etc.), a flow meter, a viscometer, a scale (e.g., to measure weight of materials, etc.), a weigh bridge, radar (e.g., free wave or guided wave radar), or any combination thereof.

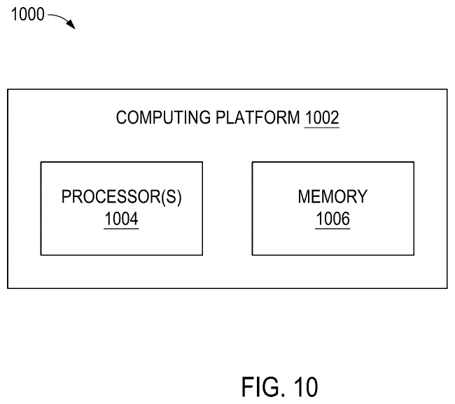

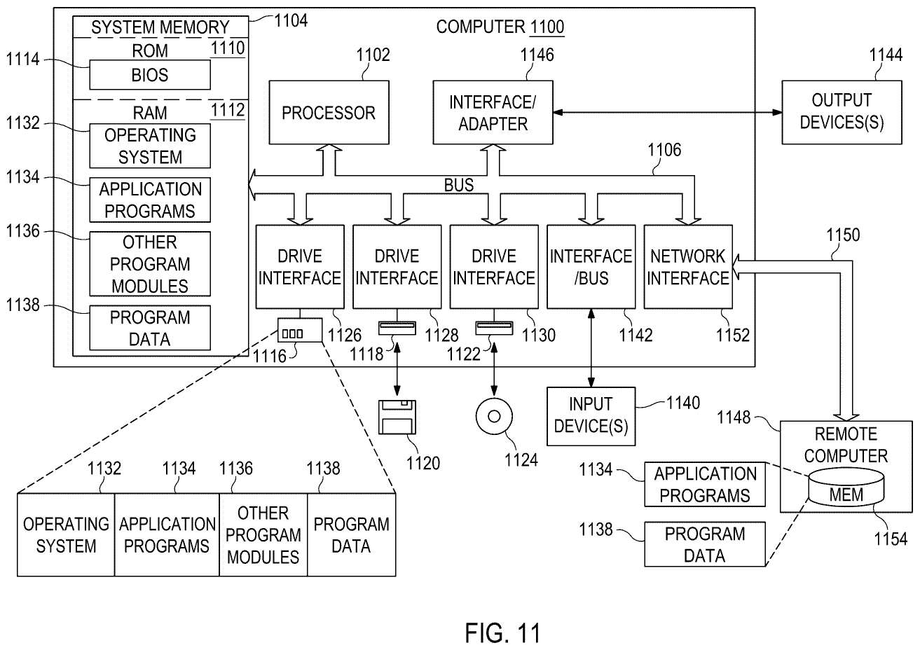

In some embodiments, the system 100 may be partially or fully automated, thus enabling remote or automated operation of the system 100. In such embodiments, the system 100 may include a control unit 128 that may be accessed (either wired or wirelessly) from a remote location, such as through satellite or Internet connections using a computer, a laptop, a handheld computing device, or the like. The control unit 128 may be a computer or computer system (e.g., the computer system of FIGS. 10-11) in communication (either wired or wireless) with one or more of the motor 110, the mixing unit 112, a feeder for the hopper 114, the valves, and the sensors 126. The control unit 128 may be programmed to communicate with such components to monitor operation of the system 100 and maintain operation thresholds within predetermined limits. Monitoring operations may include capturing digital information regarding the quality of system 100 operation. The digital information may include information such as system stress and strain information, thermal information, image information, optical information, fluid emulsification information, time differential information, flow rate information, product quality information, throughput information, and the like. Capturing may be performed by at least one monitoring device and the control unit 128. Capturing may occur at the monitoring device during a pre-defined period of time (e.g., about 1 second, about 8 hours) and may begin based on a triggering event. Examples of a triggering event include the start of system operation, the receipt by the control unit 128 of an activation command, and the like. In at least one embodiment, captured information may be sent to the control unit 128, where the information may be processed. Processing the information may include constructing at least one of digital photo information, digital video information, digital flow rate information, and digital flow quality information. The constructed information may be constructed using any structured or unstructured data format. The constructed information may be used to generate and output client alerts, console alerts, flow quality reports, images displayed on the screen, outgoing system adjustment control signals, and the like.

In at least one embodiment, the control unit 128 may be programmed to communicate with components such as the monitoring system described with respect to FIGS. 2-3. For example, the control unit 128 may serve as an access point for monitoring operations and video surveillance of various functions. In some embodiments, based on data obtained by the sensors 126, the control unit 128 may be programmed to alert a user when an operational parameter of the system 100 exceeds or descends below a predetermined limit. In other embodiments, the control unit 128 may be configured to control fluid flow based on temperature and/or pressure. In such embodiments, the control unit 128 may be programmed to stop operation of the motor 110 based on temperature and/or pressure or fluid supply tank weight.

FIG. 2 is a schematic side view of a portion of the system 100, according to one or more aspects of the present disclosure. As illustrated, the system 100 includes the hopper 114 and the mixing unit 112 in fluid communication with the hopper 114 via one or more suitable flow paths 208/216. The hopper 114 may be arranged and otherwise configured to deliver the additives 116 to the mixing unit 112 to be mixed and/or blended with the base fluid 106.

In some embodiments, the first flow path 208 may comprise a tubular conduit that includes a type of conveyance 202 operable (actuatable) to convey the additives 116 from the hopper 114 to the second flow path 216. The conveyance 202 may include, for example, an auger or a conveyor system operable to advance the additives 116 along the length of the first flow path 208. The conveyance 202 may alternatively include a rotary valve system operable to advance the additives 116 along the length of the first flow path 208. The second flow path 216 may comprise a tubular conduit that receives the additives 116 from the first flow path 208 and directs and deposits the additives 116 in the mixing unit 112. In some embodiments, the flow paths 208, 216 may be oriented perpendicular to one another, but could alternatively be oriented at other non-perpendicular angles, without departing from the scope of the disclosure.

The system 100 may further include a monitoring system that includes one or more monitoring devices 214 (one shown). The monitoring device 214 may be arranged and otherwise configured to facilitate real-time monitoring of the delivery of the additives 116 from the hopper 114 to the mixing unit 112. In the illustrated embodiment, the monitoring device 214 is arranged at or near the junction between the flow paths 208, 216, thereby obtaining a vantage point of the additives 116 being discharged from the first flow path 208 into the second flow path 216. In other embodiments, however, the monitoring device 214 may be arranged at any location along the flow paths 208, 216, without departing from the scope of the disclosure.

Monitoring operations by the monitoring device 214 may include capturing digital information regarding the quality of system 100 operation. The digital information may include information such as system stress and strain information, thermal information, image information, optical information, fluid emulsification information, time differential information, flow rate information, product quality information, throughput information, and the like. Capturing may occur at the monitoring device 214 during a pre-defined period of time (e.g., about 1 second, about 8 hours) and may begin based on a triggering event. Examples of a triggering event include the start of system 100 operation, the receipt by the control unit 128 of an activation command, and the like. In at least one embodiment, captured information may be sent to the control unit 128, where the information may be processed. Processing the information may include constructing at least one of digital photograph information, digital video information, digital flow rate information, and digital flow quality information. The constructed information may be constructed using any structured or unstructured data format. The constructed information may be used to generate and output client alerts, console alerts, flow quality reports, images displayed on the screen, outgoing system adjustment control signals, and the like.

In at least one embodiment, the monitoring device 214 may be a camera or other optical device affixed at a top of or otherwise at a ceiling of the second flow path 216. In one non-limiting example, the camera or other optical device may be a two-dimensional (2D) camera, such as a 1080P high-definition (HD) camera capable of capturing real time video. More particularly, the monitoring device 214 may be housed in a portion 224 of the second flow path 216 that is arranged or otherwise configured to facilitate a field of view 218 for the monitoring device 214 to capture the flow of the additives 116, thus allowing the monitoring device 214 to reliably capture the delivery of additives 116 to the mixing unit 112. In some applications, the field of view 218 may be arranged coaxially with the second flow path 216, and may extend to a surface (not shown) of the base fluid 106 within the mixing unit 112. In other embodiments, however, the field of view 218 may be arranged orthogonal to the second flow path 216 or at any angle between coaxial and orthogonal to the second flow path 216, without departing from the scope of the disclosure.

The monitoring device 214 may be connected to or include a power supply (not shown), allowing for continuous, semi-continuous, or event-based monitoring of flow within the second flow path 216. Event-based monitoring may be triggered by an alert or event detected within the system 100, and thereby activating the monitoring device 214 for a duration of time.

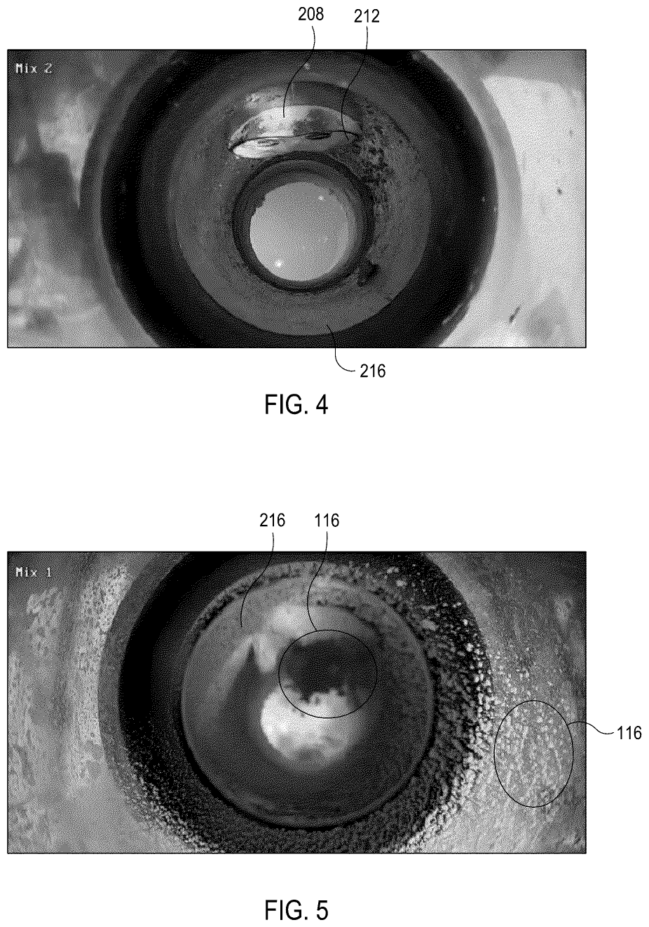

The monitoring device 214 may capture still images or video of the flow of additives 116, and may capture both activity and inactivity within system 100. An example capture of inactivity taken by the monitoring device 214 is graphically depicted in FIG. 4. In contrast, an example capture of activity taken by the monitoring device 214 is graphically depicted in FIG. 5.

In some embodiments, the system 100 can include a motor 220 arranged to drive the conveyance 202 in the first flow path 208. In embodiments where the conveyance 202 comprises an auger, a drive shaft 210 may extend from the motor 220 and is rotatable to drive the auger in rotation.

The hopper 114 may include a funneling component 206 (e.g., a funnel) arranged and otherwise configured to deliver (funnel) the additives 116 into the first flow path 208. In some embodiments, the first flow path 208 may be arranged and otherwise configured to deliver the additives 116 to the second flow path 216 through an opening 212 defined in a sidewall of the second flow path 216 where the first flow path 208 intersects the second flow path 216. The opening 212 is arranged vertically below the portion 224 of the second flow path 216.

The dosage rate of the additive 116 to the mixing unit 112 may vary depending on the application and depending on what type of working fluid 118 is desired. More specifically, in some embodiments, the rate at which the additive 116 is introduced into the mixing unit 112 may be controlled by volume or weight to accord with a corresponding dosage rate of the base fluid into the mixing unit 112. Control over the dosage rate may be accomplished by adjusting the speed of the conveyance 202, or possibly by adjusting a valve operatively coupled to the hopper 114 and otherwise interposing the hopper 114 and the mixing unit 112.

FIG. 3 is an enlarged, schematic side view of an example monitoring system 300 according to one or more aspects of the present disclosure. In some embodiments, the system 300 may be partially or fully automated, thus enabling remote or automated operation. In such embodiments, the system 300 may include the control unit 128 coupled to the monitoring device 214 via connection 304, which may be accessed (either wired or wirelessly) from a remote location, such as through satellite or Internet connections using a computer, a laptop, a handheld computing device, or the like. The control unit 128 may be a computer or computer system (e.g., the computer system of FIGS. 10-11) in communication (either wired or wirelessly) with the monitoring device 214. The control unit 128 may be programmed to communicate with such components, such as a user console or another controller, to monitor operation of the system 300 and maintain operation thresholds within predetermined limits. In at least one embodiment, a console is a digital or analog platform operable to receive input information (e.g., via a guided user interface, by an analog dial system), process the input information to generate control signals, and output the control signals to the control unit 128. In at least one embodiment, the console is operable to obtain captured information from the control unit 128.

In at least one embodiment, the control unit 128 may be programmed to communicate with such components, such as the system 100 (FIGS. 1 and 2) and the system 300. For example, the control unit 128 may serve as an access point for monitoring operations and video surveillance of various functions. In some embodiments, based on data obtained by the sensors 126 (FIG. 1), the control unit 128 may be programmed to alert a user when an operational parameter of the system 300 exceeds or descends below a predetermined limit. In other embodiments, the control unit 128 may be configured to control fluid flow based on temperature and/or pressure. In such embodiments, the control unit 128 may be programmed to stop operation of the motor 110 based on temperature and/or pressure or fluid supply tank weight.

According to embodiments of the present disclosure, the control unit 128 may be configured to implement machine learning techniques to achieve various functions described above. The machine learning techniques implemented by the control unit 128 may constitute one or more technical improvements over conventional monitoring system operations by enhancing the real-time monitoring capabilities available within blending systems. Additionally, one or more embodiments described herein can have a practical application by training machine learning models to perform the monitoring operations in accordance with defined blending system objectives. For example, one or more embodiments described herein can capture flow quality within a portable blending system and adjust the blending system to achieve optimal flow quality.

As used herein, the term “machine learning” can refer to an application of artificial intelligence technologies to automatically and/or autonomously learn and/or improve from an experience (e.g., training data) without explicit programming of the lesson learned and/or improved upon. Machine learning as used herein can include, but is not limited to, deep learning techniques. Various system components described herein can utilize machine learning (e.g., via supervised, unsupervised, and/or reinforcement learning techniques) to perform tasks such as classification, regression, and/or clustering. Execution of machine learning tasks can be facilitated by one or more machine learning models trained on one or more training datasets in accordance with one or more model configuration settings.

As used herein, the term “machine learning model” can refer to a computer model used to facilitate one or more machine learning tasks (e.g., regression and/or classification tasks). For example, a machine learning model can represent relationships (e.g., causal or correlation relationships) between parameters and/or outcomes within the context of a specified domain. For instance, machine learning models can represent the relationships via probabilistic determinations that can be adjusted, updated, and/or redefined based on historic data and/or previous executions of a machine learning task. In various embodiments described herein, machine learning models can simulate a number of interconnected processing units that can resemble abstract versions of neurons. For example, the processing units can be arranged in a plurality of layers (e.g., one or more input layers, hidden layers, and/or output layers) connected by varying connection strengths (e.g., which can be commonly referred to within the art as “weights”).

Machine learning models can learn through training with one or more training datasets; where data with known outcomes in inputted into the machine learning model, outputs regarding the data are compared to the known outcomes, and/or the weights of the machine learning model are autonomously adjusted based on the comparison to replicate the known outcomes. As the one or more machine learning models train (e.g., utilize more training data), the machine learning models can become increasingly accurate; thus, trained machine learning models can accurately analyze data with unknown outcomes, based on lessons learned from training data and/or previous executions, to facilitate one or more machine learning tasks.

Example types of machine learning models can include, but are not limited to: artificial neural network (“ANN”) models, perceptron (“P”) models, feed forward (“FF”) models, radial basis network (“RBF”) models, deep feed forward (“DFF”) models, recurrent neural network (“RNN”) models, long/short memory (“LSTM”) models, gated recurrent unit (“GRU”) models, auto encoder (“AE”) models, variational AE (“VAE”) models, denoising AE (“DAE”) models, sparse AE (“SAE”) models, markov chain (“MC”) models, Hopfield network (“HN”) models, Boltzmann machine (“BM”) models, deep belief network (“DBN”) models, convolutional neural network (“CNN”) models, deep convolutional network (“DCN”) models, deconvolutional network (“DN”) models, deep convolutional inverse graphics network (“DCIGN”) models, generative adversarial network (“GAN”) models, liquid state machine (“LSM”) models, extreme learning machine (“ELM”) models, echo state network (“ESN”) models, deep residual network (“DRN”) models, kohonen network (“KN”) models, support vector machine (“SVM”) models, and/or neural turing machine (“NTM”) models.

In at least one embodiment, a machine learning engine may be applied to information captured by a monitoring device and stored at a controller. In one non-limiting example, the machine learning engine may be a classifying engine trained to detect and characterize additive 116 flow. The example classifying engine may detect an about 0% flow rate of additive 116 (inactivity) and return an inactivity value and/or alert. The example classifying engine may detect a less than about 50% flow (low activity) and return a low activity value and/or alert. The example classifying engine may detect a more than about 50% flow (moderate activity) and return a moderate activity value and/or alert. The example classifying engine may detect a more than about 85% flow (high activity) and return a moderate activity value and/or alert. The example classifying engine may detect a flow percent value within a predetermined and preferred operating range of flow (e.g., between about 75% and about 90%) and return a moderate activity value and/or alert.

In at least one embodiment, the machine learning engine may include a training engine configured to train a machine learning model and an inference engine configured to apply the machine learning model. In at least one embodiment, applying a machine learning engine to the information further includes applying one or more weights to the information based on a flow of the additive to generate additive flow data. In at least one embodiment, the training engine is configured to train a machine learning model by inputting a training dataset, the training data set comprising historical flow rate activity data, comparing, to the training dataset, an output of the training engine, the output of the training engine comprising predicted flow quality data, and, based on the comparing, adjusting one or more weights of the machine learning model. In at least one embodiment, wherein the flow quality data comprises a flow rate classification, such as the “inactivity”, “low activity”, “moderate activity”, and “high activity” classifications described above. In at least one embodiment, both the historical flow rate activity data and the flow quality data include at least one of image information regarding additive flows, time information regarding additive flows, flow velocity information regarding additive flows, flow level information regarding additive flows, and system design information regarding additive flows. At the training engine, the flow quality data may be generated from the historical flow rate data. At the inference engine, the flow quality data may be generated from the information capture regarding the flow of additive 116.

Referring now to FIG. 4, illustrated is an example capture of inactivity taken by the monitoring device 214 of FIG. 2, according to one or more embodiments. More specifically, FIG. 4 graphically depicts an example field of view 218 for the monitoring device 214 during inactivity of the system 100 (FIGS. 1 and 2). As illustrated, the field of view 218 of the monitoring device 214 is directed towards the mixing unit 112 (i.e., into the page, but not visible), coaxial with the second flow path 216. The opening 212 of the first flow path 208 is visible within the field of view 218 and is depicted as being located along the cylindrical sidewall of the second flow path 216.

Accordingly, the field of view 218 allows real-time monitoring of activity and inactivity within the system 100. For example, the field of view 218 allows an operator to see and otherwise determine if additives 116 (FIGS. 1 and 2) are being conveyed from the first flow path 208 to the second flow path 216. When no additives 116 are present within the field of view 218, that may be an indication of inactivity of the system 100. As used herein, the term “inactivity” refers to the lack of additives 116 being conveyed from the first flow path 208 to the second flow path 216, which could occur for a variety of reasons including, but not limited to, the storage of additive 116 in the hopper 114 (FIGS. 1 and 2) has depleted, the conveyance 202 (FIG. 2) stopped working (either intentionally or unintentionally), there is a blockage in the first flow path 208 that prevents the additives 116 from reaching the second flow path 216, there is a blockage in the second flow path 216 or the mixing unit 112, loss of power to the system 100, or any combination thereof. Accordingly, it is contemplated herein that the monitoring device 214 be used to detect and determine if a blockage is present downstream of the monitoring device 214.

The image capture depicted in FIG. 4 may be considered a single photographic image, which in turn may be one of a sequence of photographic images collected as part of a digital video capture taken as part of a monitoring period.

Referring now to FIG. 5, illustrated is an example capture of activity taken by the monitoring device 214 of FIG. 2, according to one or more embodiments. More specifically, FIG. 5 graphically depicts the field of view 218 for the monitoring device 214 during activity of the system 100 (FIGS. 1 and 2) when the additives 116 are being discharged from the opening 212 in the first flow path 208 and allowed to flow into the second flow path 216. The real-time monitoring of activity may allow the system 100 to collect and process (e.g., by way of the control unit 128) information regarding the additive 116 flow, such as flow rate information, flow quality information, flow volume information, flow emulsification information, and the like. Similar to FIG. 4, the capture of FIG. 5 may be considered a single photographic image, which in turn may be one of a sequence of photographic images collected as part of a digital video capture taken as part of a monitoring period.

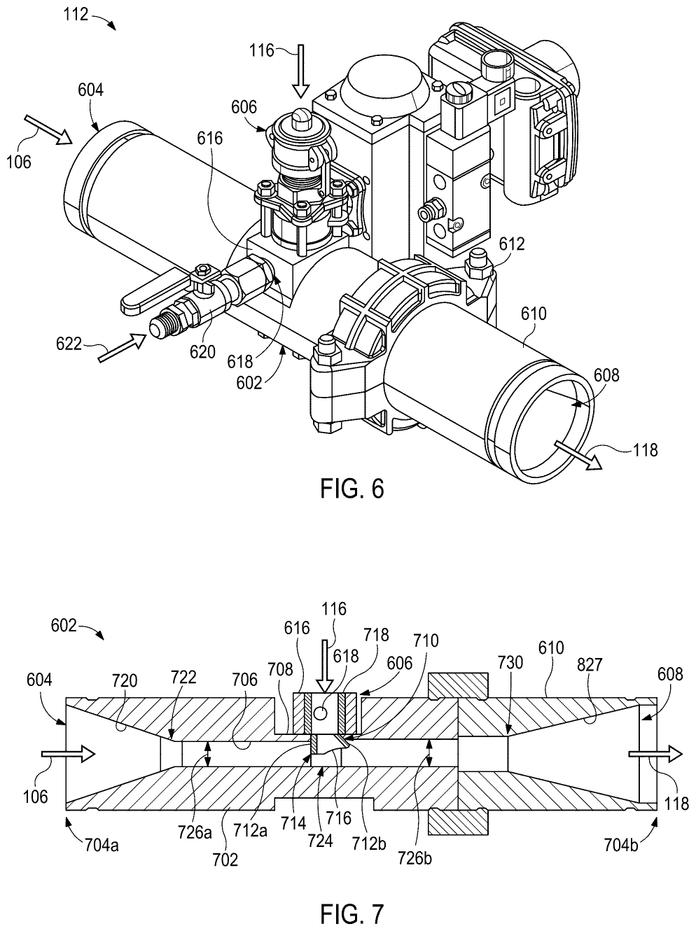

FIG. 6 is a cross-sectional side view of one example of the mixing unit 112, according to one or more embodiments. As illustrated, the mixing unit 112 includes an extender 602 having a fluid inlet 604, an additive inlet 606, and an outlet 608.

The base fluid 106 is introduced into the extender 602 via the fluid inlet 604, and the additive 116 is introduced into the extender 602 via the additive inlet 606. As described above, the additive 116 may be fed into the additive inlet 606 from the hopper 114. The working fluid 118 may exit the extender 602 via the outlet 608 to be conveyed to the downstream location 124 (FIG. 1), as generally described above.

The geometry of the extender 602 may cause the base fluid 106 to form a jet that flows through the extender 602 and generates a low-pressure vacuum that draws the additive 116 into the mixing device 106 to mix with the base fluid 106. The formation of the jet also imparts energy to the mixture to help hydrate the additive 116.

In some embodiments, the outlet 608 may be formed by a diffuser 610 coupled to the extender 602 at a coupling 612. In other embodiments, however, the diffuser 610 may form an integral part or extension of the extender 602.

The additive inlet 606 may include a second valve (not shown) to regulate flow of the additive 116 into the mixing unit 112 and, more particularly, into the extender 602. The second valve, referred to herein as the “additive valve” may comprise, for example, a ball valve that may be manually operated or operated by automation using the control unit 128 (FIG. 1). In the illustrated embodiment, the additive inlet 606 may further include a spacer 616 interposing the additive valve and the extender 602. The spacer 616 may define a flush port 618 and a flush valve 620 may be fluidly coupled to the spacer 616 at the flush port 618. The flush valve 620 may be actuated as needed to introduce a flushing fluid 622 into the extender 602 to remove any buildup of the additive 116 that may be coated on the inner walls of the spacer 616 and a suction port that feeds the additive 116 into the extender 602. Similar to the additive valve, the flush valve 620 may be manually operated or operated by automation using the control unit 128.

When it is desired to flush the system, the additive valve may be closed (either manually or automated), and the flush valve 620 may be opened (either manually or automated) to allow the flushing fluid 622 to enter the spacer 616 and the extender 602. The flushing fluid 622 may be any fluid that may sufficiently remove built-up additive 116 including, but not limited to, water (e.g., fresh or salt), a gas (e.g., air, nitrogen, carbon dioxide, etc.), a hydrocarbon (e.g., ethanol, methanol, etc.), or any combination thereof. In at least one embodiment, the flushing fluid 622 may comprise a portion of the base fluid 106 separated from the main portion and piped to the flush valve 620.

FIG. 7 is a cross-sectional side view of a nonlimiting embodiment of the extender 602. As illustrated, the extender 602 includes an elongate body 702 having a first end 704a and a second end 704b. The fluid inlet 604 is provided at the first end 704a, the outlet 608 is provided at the second end 704b, and a throat 706 extends between the fluid inlet 604 and the outlet 608. In some embodiments, the extender 602 may be made of a metal, such as carbon steel, stainless steel (e.g., polished stainless steel, chrome plated steel, etc.), aluminum, any alloys thereof, or any combination thereof. Alternatively, the extender 602 may be made of a plastic or polymer, such as polytetrafluoroethylene (PTFE or TEFLON®), NYLON®, HYLON®, polyvinyl chloride (PVC), chlorinated polyvinyl chloride (CPVC), or any combination thereof. In one or more embodiments, a hydrophobic coating may be applied to the inner walls of some or all of the extender 602. In yet other embodiments, the inner walls of some or all of the extender 602 may be polished to reduce friction.

Only a portion of the additive inlet 606 is depicted in FIG. 7. More particularly, the additive valve (FIG. 6) is omitted, but the spacer 616 is depicted and defines the flush port 618 through which the flushing fluid 622 (FIG. 6) can be injected into the extender 602. In the illustrated embodiment, a recessed portion or “cutout” 708 is defined in the outer wall of the body 702, and the additive inlet 606 may be secured to the extender 602 within the cutout 708. Mounting the additive inlet 606 to the extender 602 within the cutout 708 helps to mitigate the occurrence of the additive 116 coating (covering) the inner walls of the additive inlet 606.

The additive inlet 606 may further include a suction port 710 that extends from the spacer 616 and communicates with the extender 602 at an intermediate point between the first and second ends 704a,b. In at least one embodiment, as illustrated, the suction port 710 may extend into the throat 706 of the extender 602. In such embodiments, the suction port 710 may be generally cylindrical and may expand or otherwise flare outward as it extends into the throat 706. The diameter of the suction port 710 at or near the spacer 616 may be smaller than the diameter of the suction port 710 at its opposing end within the throat 706. This may prove advantageous in providing a larger discharge area for the additive 116 to be combined with the base fluid 106 flowing through the throat 706.

In some embodiments, a leading (upstream) edge 712a of the suction port 710 may extend deeper (further) into the throat 706 as compared to a trailing (downstream) edge 712b of the suction port 710. This may prove advantageous in helping to prevent the incoming additive 116 from rebounding off the jet of base fluid 106 flowing through the throat 706 and splashing back onto portions of the suction port 710. Moreover, in at least one embodiment, the leading edge 712a may define or provide a beveled bottom edge 714 and the suction port 710 may define a chamfered portion 716 that facilitates the transition between the leading and trailing edges 712a,b. The beveled bottom edge 714 and the chamfered portion 716 may be designed to help minimize or prevent splashing of the additive 116 as it is introduced into the throat 706.

In some embodiments, the suction port 710 may be made of a metal, such as carbon steel, stainless steel (e.g., polished stainless steel, chrome plated steel, etc.), aluminum, any alloys thereof, or any combination thereof. Alternatively, the suction port 710 may be made of a plastic or a polymer, such as polytetrafluoroethylene (PTFE or TEFLON®), NYLON®, HYLON®, polyvinyl chloride (PVC), chlorinated polyvinyl chloride (CPVC), or any combination thereof. In yet other embodiments, or in addition thereto, all or a portion of the spacer 616 and the suction port 710 may be lined with a lubricious material 718, such as CPVC. The lubricious material 718 may help repel the additive 116 and help facilitate a cleaner flushing when the flush port 618 is used to introduce the flushing fluid 622 (FIG. 6) to remove any buildup of the additive 116 that may be coated on the inner walls of the spacer 616 and the suction port 710. In at least one embodiment, the lubricious material 718 may further line the inner walls of the additive valve (FIG. 6).

In embodiments that include flushing capabilities, the extender 602 may be cleaned and flushed at periodic intervals, such as at every 20 minutes of operation, or every 30 minutes, every hour, etc. In such embodiments, the control unit 128 (FIG. 1) may autonomously control operation of the flushing operations. The control unit 128 may also use various flow and pressure measurements to ensure that the extender 602 is maintaining suitable suction conditions. In the event any parameters deviate from normal values, the control unit 128 may cause the additive valve (FIG. 6) to close to eliminate a backflush condition through the suction line, and initiate a flush of the extender 602.

The extender 602 may also be flushed before and/or after the mixing (blending) process is completed. Flushing the extender 602 prior to starting a mixing process may prove advantageous since if there is any additive 116 already built up on the inner walls of the extender 602 (e.g., the additive valve of FIG. 6, the spacer 616, and the suction port 710), it will have already absorbed water and softened, thus making it much easier to flush it as opposed to a fresh build-up of the additive 116. In some embodiments, the entire fluid pressure force of the pump 108 (FIGS. 1 and 2-4) may be used in the flushing process.

The throat 706 may form an elongated passageway that helps elongate and unfold a polymer structure of the additive 116 with minimum damage. More specifically, the geometry of the extender 602 may help ensure that the base fluid 106 flowing through the throat 706 smoothly converges and mitigates splashing where the additive 116, especially dry additive 116, is introduced into the stream at the suction port 710. More particularly, the fluid inlet 604 may define or otherwise provide a converging portion 720 that tapers inward to form a nozzle. The base fluid 106 forms a jet as it is forced to transition from the converging portion 710 to the throat 706.

In some embodiments, the converging portion 720 may transition to the throat 706 at an arcuate transition 722 that exhibits a radius. As opposed to a sharp corner transition, the arcuate transition 722 provides smooth and curved transition walls. The radius and arcuate length of the arcuate transition 722 may be determined based on the remaining geometry of the extender 602. In at least one embodiment, the arcuate length of the arcuate transition 722 may be about 2.0 inches, but could alternatively be less than or greater than 2.0 inches, without departing from the scope of the disclosure. The arcuate transition 722 may help the flow of the base fluid 106 to become extensional and smooth, with little or no turbulence, as it forms the jet flowing into the throat 706, and smoother flow of the base fluid 106 may help prevent splashing as the additive 116 enters the throat 706 at the suction port 710.

During example operation, in some embodiments, opening of the additive valve (FIG. 6) to introduce the additive 116 may be delayed for a short period (e.g., 5 or more seconds) to allow the flow of the base fluid 106 through the throat 706 to become extensional. Once proper conditions are attained, the additive valve can be opened to start feeding the additive 116 and forming the working fluid 118.

In some embodiments, the diameter of the throat 706 may increase at or near the suction port 710 and otherwise where the additive 116 is introduced into the throat 706. More specifically, the throat 706 may define an expansion transition 724 that increases the diameter of the throat 706 in the downstream direction. Consequently, the diameter 726a of the throat 706 upstream from the expansion transition 724 may be smaller than the diameter 726b of the throat 706 downstream from the expansion transition 724. Increasing the diameter of the throat 706 at or near the suction port 710 may prove advantageous in removing the jet of base fluid 106 from the walls of the throat 706 at that point so that it does not impinge directly on abrupt structural edges of the suction port 710. The expansion transition 724 also provides additional room for the additive 116 to be introduced into the throat 706.

The diffuser 610 extends the length of the throat 706 and provides or otherwise defines a diverging portion 728 that tapers outward in the downstream direction. The throat 706 may transition to the diverging portion 728 at a transition 730. In some embodiments, as illustrated, the transition 730 may provide a sharp corner transition. In other embodiments, however, the transition 730 may provide a smooth, curved transition across an arcuate portion having a radius, without departing from the scope of the disclosure.

In a preferred embodiment, the additive 116 comprises a polymer, such as a polyacrylamide. The extensional flow generated by the extender 602 tends to keep the polymer structure of the additive 116 more intact, and tends to stretch the polymer without breaking it, thus improving its shear resistance and dynamic proppant transport capability. The mixing unit 112 (FIG. 6) may be able to produce a flow of the base fluid 106 with a minimum amount of wasted energy in the form of turbulence, and the additive 116 (e.g., polymer) is added to this stream. This allows the additive 116 to be wetted and then begin its structure development. The smooth, extensional flow pattern helps achieve elongation and unfolding of the polymer structure with a minimum of damage (e.g., shortening of the polymer chain).

In some embodiments, the downstream location 124 (FIG. 1) may comprise a hydration tank that also helps improve shear resistance and dynamic proppant transport capability in that it may keep the additive 116, which is now partially hydrated, in a constant but controlled movement (e.g., spiral flow). This step may complete the stretching of the polymer chains and maximize the area that the polymer structure covers. Combining these two blending steps may complete the required structural development process.

Maximizing the polymer concentration that is reached using this process allows the mixing device 106 (FIG. 1) to support a relatively high polymer concentration and, in turn, be capable of handling of the polymer requirement for a high injection rate through the downstream equipment 124 (FIG. 1).

With reference again to FIG. 1, the control unit 128 may include an onboard computer system or may transmit data to an external computer system for processing and/or display of results. For the purposes of this disclosure, “coupled” as used herein is intended to mean coupling of components or subsystems in a way to permit communication of information between the components or subsystems. Two components or subsystems may be communicatively coupled through a wired or wireless communication network, including but not limited to Ethernet, LAN, fiber optics, radio, microwaves, Bluetooth, satellite, and the like. Operation and use of such communication networks is well known to those of ordinary skill in the art and will, therefore, not be discussed in detail herein.

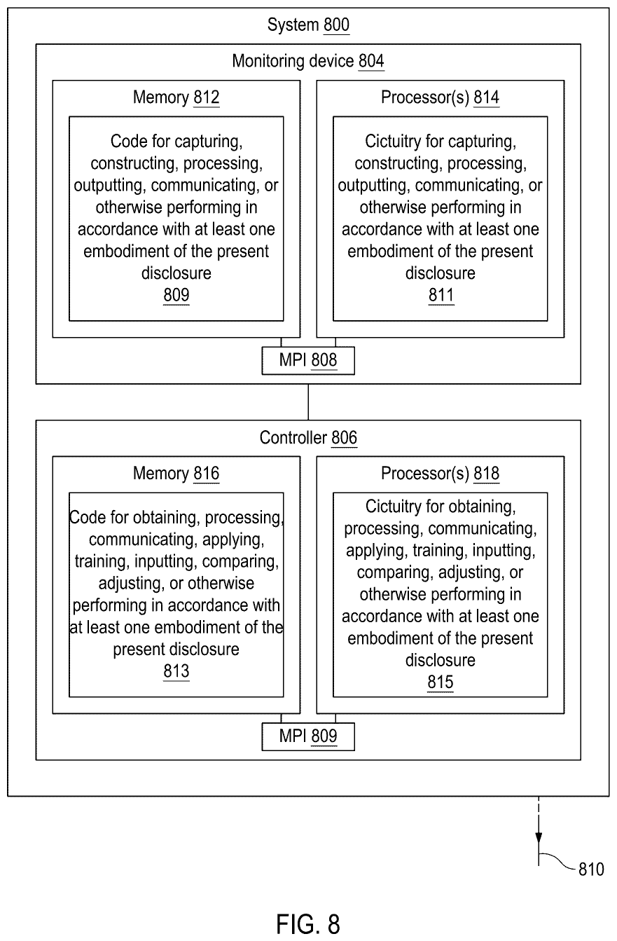

FIG. 8 is a schematic diagram of an example monitoring system 800. The monitoring system 800 may be comparable to the monitoring systems 300 and 400. The monitoring system may include a monitoring device 804 and a controller 806 configured to monitor systems for transportable or modular systems designed for the formulation of various fluid compositions.

The monitoring device 804 may include a CPU processing system, which may be configured to capture images and videos of flow through a system. The CPU processing system of the monitoring device 804 may include one or more processors 814 coupled to a computer readable medium/memory 812 via a bus. The one or more processors 814 and the computer readable medium/memory 812 may communicate via a message passing interface (MPI) 808. In certain aspects the computer readable medium/memory 812 is configured to store instruction (e.g., computer executable code) that when executed by the one or more processors 814, cause the one or more processors to perform the method 1000 described with respect to FIG. 10, or any aspect related to it. Reference to a processor performing a function of monitoring system 800 may include one or more processors performing that function of monitoring system 800.

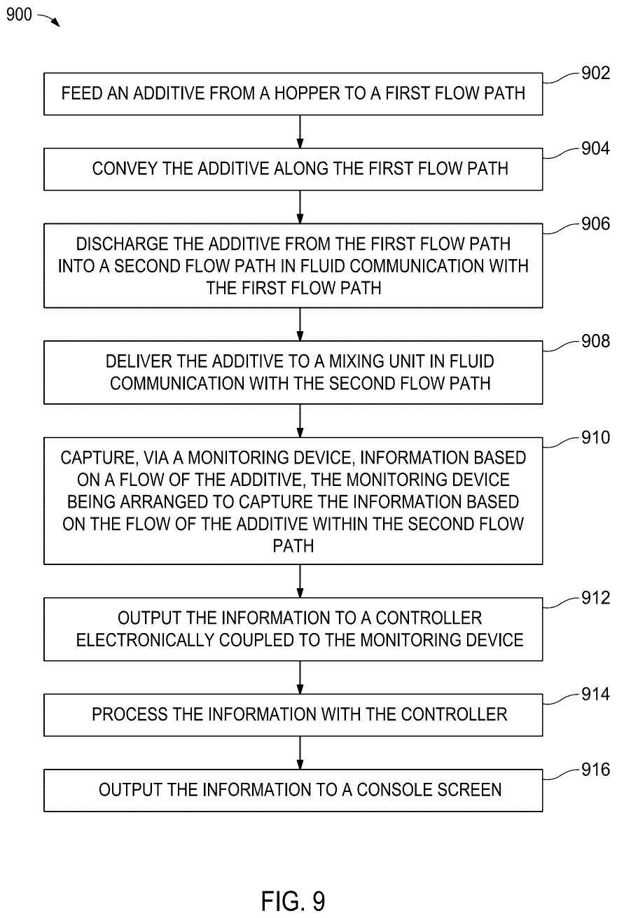

In the depicted example, computer-readable medium/memory 814 stores code (e.g., executable instructions) for capturing, constructing, processing, outputting, communicating, or otherwise performing in accordance with at least one embodiment of the present disclosure. Processing of code 809 may cause the monitoring system 800 to perform the method 900 described with respect to FIG. 9, or any aspect related to it.

The one or more processors 814 include circuitry configured to implement (e.g., execute) the code stored in the computer-readable medium/memory 812, including circuitry for capturing, constructing, processing, outputting, communicating, or otherwise performing in accordance with at least one embodiment of the present disclosure. Processing with circuitry 811 may cause the monitoring system 800 to perform the method 900 described with respect to FIG. 9, or any aspect related to it.

The controller 806 may include a CPU processing system. The CPU processing system may be configured to control the monitoring device 804. The CPU processing system of the override control component 806 may include one or more processors 818. The one or more processors 818 are coupled to a computer readable medium/memory 816 via a bus. The one or more processors 818 and the computer readable medium/memory 816 may communicate via an MPI 809. In certain aspects the computer readable medium/memory 816 is configured to store instruction (e.g., computer executable code) that when executed by the one or more processors 818, cause the one or more processors to perform the method 900 described with respect to FIG. 9, or any aspect related to it. Reference to a processor performing a function of the monitoring system 800 may include one or more processors performing that function of the monitoring system 800.

In the depicted example, computer-readable medium/memory 818 stores code (e.g., executable instructions) for obtaining, processing, communicating, applying, training, inputting, comparing, adjusting, or otherwise performing in accordance with at least on embodiment of the present disclosure. Processing of code 813 may cause the monitoring system 800 to perform the method 900 described with respect to FIG. 9, or any aspect related to it.

The one or more processors 818 include circuitry configured to implement (e.g., execute) the code stored in the computer-readable medium/memory 816, including circuitry for obtaining, processing, communicating, applying, training, inputting, comparing, adjusting, or otherwise performing in accordance with at least on embodiment of the present disclosure. Processing with circuitry 815 may cause the monitoring system 800 to perform the method 900 described with respect to FIG. 9, or any aspect related to it.

Various components of the monitoring system 800 may provide means for performing the method 900 described with respect to FIG. 9, or any aspect related to it.

The monitoring device 804 may communicate with the controller 806 to perform the method 900 described with respect to FIG. 9, or any aspect related to it. In one example, the monitoring device 804 may be coupled to the controller 806 via bus. The auto-start monitoring device 804 and the controller 806 may communicate via an MPI 809, a land area network (LAN), a fiber optic connection, or another type of wired communication. In one example, the monitoring device 804 may be coupled to the controller 806 wirelessly. The auto-start monitoring device 804 and the controller 806 may communicate via a wireless LAN, a Bluetooth spectrum connection, a cellular network, a satellite network, a near field connection (NFC), or another type of wireless network.

The monitoring system 800 may include a communication component 810. In the depicted example, the communication component 810 is an antenna capable of communicating with controllers similar to monitoring system 800 to perform the method 900 described with respect to FIG. 9, or any aspect related to it. In additional examples, the communication component 810 may be a bus or a wired connection.

Data collected can be transferred by the transmitter to a computer system present at the work site or at a remote location that collects, processes, and displays data directly or through a secondary computer system such as a laptop or portable device. Computer systems of the present disclosure include personal computers (e.g., desktop or laptop), tablet computers, mobile devices (e.g., personal digital assistant (PDA) or Smartphone), servers (e.g., blade server or rack server), a network storage devices, or any other suitable computing device and may vary in size, shape, performance, functionality, and price.

FIG. 9 is a schematic flowchart of an example method 900 for monitoring systems for transportable or modular systems by one or more processors, such as the processors of monitoring system 800 of FIG. 8.

Method 900 begins at operation 902, with a monitoring system feeding an additive from a hopper to a first flow path.

Method 900 continues at operation 904, with a monitoring system conveying the additive along the first flow path.

Method 900 continues at operation 906, with a monitoring system discharging the additive from the first flow path into a second flow path in fluid communication with the first flow path.

Method 900 continues at operation 908, with a monitoring system delivering the additive to a mixing unit in fluid communication with the second flow path.

Method 900 continues at operation 910, with a monitoring system capturing, via a monitoring device, information based on a flow of the additive, the monitoring device being arranged to capture the information based on the flow of the additive within the second flow path. In at least one example, the monitoring device is arranged such that the monitoring device captures a field of view where the first flow path intersects the second flow path. In at least one example, the monitoring device is arranged such that the monitoring device captures a field of view coaxial with the second flow path. In at least one example, the monitoring device includes a camera. In at least one example, the monitoring device is further configured to capture the information based on a flow of the additive in a continuous manner, in a semi-continuous manner, or in an event-based manner.

Method 900 continues at operation 912, with a monitoring system outputting the information to a controller electronically coupled to the monitoring device. In at least one example, the controller is configured to process the information based on a flow of the additive by applying a machine learning engine to the information, the machine learning engine comprising a training engine configured to train a machine learning model and an inference engine configured to apply the machine learning model. In at least one example, the training engine trains a machine learning model by: inputting a training dataset, the training data set comprising historical flow rate activity data; comparing, to the training dataset, an output of the training engine, the output of the training engine comprising predicted flow quality data; and based on the comparing, adjusting one or more weights of the machine learning model. In at least one example, the predicted flow quality data includes a flow rate classification. In at least one example, the historical flow rate activity data and the flow quality data comprise at least one of image information, time information, flow velocity information, flow level information, and system design information. In at least one example, applying a machine learning engine to the information further comprises applying one or more weights to the information based on a flow of the additive to generate additive flow data.

Method 900 continues at operation 914, with a monitoring system processing the information with the controller. In at least one example, processing the information with the controller includes constructing at least one of photo information, video information, flow rate information, and flow quality information.

Method 900 continues at operation 916, with a monitoring system outputting the information to a console screen.

In at least one embodiment, the method 900 may include a monitoring system conveying the additive along the first flow path from the hopper to the second flow path with a conveyance arranged within the first flow path; and adjusting, via the controller, at least one of the conveyance and the mixing unit.

FIG. 9 is just one example of a method, and other methods including fewer, additional, or alternative operations are contemplated consistent with the disclosure.

FIG. 10 is an example of a block diagram of a system 1000. The one or more modules can be in software or hardware form, or a combination thereof. In some examples, the system 1000 can be implemented as machine readable instructions for execution on one or more computing platforms 1002 (referred to as a computing platform herein), as shown in FIG. 10. The computing platform 1002 can include one or more computing devices selected from, for example, a desktop computer, a server, a controller, a blade, a mobile phone, a tablet, a laptop, a personal digital assistant (PDA), and the like.

The computing platform 1004 can include a processor 1004 and a memory 1006. By way of example, the memory 1006 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 1004 can be implemented, for example, as one or more processor cores. The memory 1006 can store machine-readable instructions that can be retrieved and executed by the processor 1004 to implement the system 1000. Each of the processor 1004 and the memory 1006 can be implemented on a similar or a different computing platform. The computing platform 1002 can be implemented in a cloud computing environment (for example, as disclosed herein) and thus on a cloud infrastructure. In such a situation, features of the computing platform 1002 can be representative of a single instance of hardware or multiple instances of hardware executing across the multiple of instances (e.g., distributed) of hardware (e.g., computers, routers, memory, processors, or a combination thereof). Alternatively, the computing platform 1002 can be implemented on a single dedicated server or workstation. In view of the structural and functional features described above, example methods will be better appreciated with reference to FIG. 5.

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 11. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard, FIG. 11 illustrates one example of a computer system 1100 that can be employed to execute one or more embodiments of the present disclosure. Computer system 1100 can be implemented on one or more general purpose networked computer systems, embedded computer systems, routers, switches, server devices, client devices, various intermediate devices/nodes or standalone computer systems. Additionally, computer system 1100 can be implemented on various mobile clients such as, for example, a personal digital assistant (PDA), laptop computer, pager, and the like, provided it includes sufficient processing capabilities.

Computer system 1100 includes processing unit 1102, system memory 1104, and system bus 1106 that couples various system components, including the system memory 1104, to processing unit 1102. System memory 1104 can include volatile (e.g. RAM, DRAM, SDRAM, Double Data Rate (DDR) RAM, etc.) and non-volatile (e.g. Flash, NAND, etc.) memory. Dual microprocessors and other multi-processor architectures also can be used as processing unit 1102. System bus 1106 may be any of several types of bus structure including a memory bus or memory controller, a peripheral bus, and a local bus using any of a variety of bus architectures. System memory 1104 includes read only memory (ROM) 1110 and random access memory (RAM) 1112. A basic input/output system (BIOS) 1114 can reside in ROM 1110 containing the basic routines that help to transfer information among elements within computer system 1100.

Computer system 1100 can include a hard disk drive 1116, magnetic disk drive 1118, e.g., to read from or write to removable disk 1120, and an optical disk drive 1122, e.g., for reading CD-ROM disk 1124 or to read from or write to other optical media. Hard disk drive 1116, magnetic disk drive 1118, and optical disk drive 1122 are connected to system bus 1106 by a hard disk drive interface 1126, a magnetic disk drive interface 1128, and an optical drive interface 1130, respectively. The drives and associated computer-readable media provide nonvolatile storage of data, data structures, and computer-executable instructions for computer system 1100. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A user may enter commands and information into computer system 1100 through one or more input devices 1140, such as a pointing device (e.g., a mouse, touch screen), keyboard, microphone, joystick, game pad, scanner, and the like. For instance, the user can employ input device 1140 to edit or modify initial control signals received from an auto-start logic component, as described herein. These and other input devices 1140 are often connected to processing unit 1102 through a corresponding port interface 1142 that is coupled to the system bus, but may be connected by other interfaces, such as a parallel port, serial port, or universal serial bus (USB). One or more output devices 1144 (e.g., display, a monitor, printer, projector, or other type of displaying device) is also connected to system bus 1106 via interface 1146, such as a video adapter.

Computer system 1100 may operate in a networked environment using logical connections to one or more remote computers, such as remote computer 1148. Remote computer 1148 may be a workstation, computer system, router, peer device, or other common network node, and typically includes many or all the elements described relative to computer system 1100. The logical connections, schematically indicated at 1150, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 1100 can be connected to the local network through a network interface or adapter 1152. When used in a WAN networking environment, computer system 1100 can include a modem, or can be connected to a communications server on the LAN. The modem, which may be internal or external, can be connected to system bus 1106 via an appropriate port interface. In a networked environment, application programs 1134 or program data 1138 depicted relative to computer system 1100, or portions thereof, may be stored in a remote memory storage device 1154.

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models (e.g., software as a service (Saas, platform as a service (PaaS), and/or infrastructure as a service (IaaS)) and at least four deployment models (e.g., private cloud, community cloud, public cloud, and/or hybrid cloud). A cloud computing environment can be service oriented with a focus on statelessness, low coupling, modularity, and semantic interoperability.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

### Embodiments Disclosed Herein Include

A. A system for blending fluids including a hopper that contains an additive. The system also including a first flow path extending from the hopper and operable to receive the additive from the hopper and convey the additive along a length of the first flow path and a second flow path in fluid communication with the first flow path to receive the additive from the first flow path. The system also including a mixing unit in fluid communication with the second flow path to receive the additive from the second flow path. The system also including a monitoring device arranged within the second flow path and operable to capture information based on a flow of the additive within the second flow path. The system also including a controller electronically coupled to the monitoring device and operable to process the captured information and output the information to a console screen.

B. A method including feeding an additive from a hopper to a first flow path. The method also including conveying the additive along the first flow path. The method also includes discharging the additive from the first flow path into a second flow path in fluid communication with the first flow path. The method also includes delivering the additive to a mixing unit in fluid communication with the second flow path. The method also includes capturing, via a monitoring device, information based on a flow of the additive, the monitoring device being arranged to capture the information based on the flow of the additive within the second flow path. The method also includes outputting the information to a controller electronically coupled to the monitoring device. The method also includes processing the information with the controller. The method also includes outputting the information to a console screen.

Each of embodiments A and B may have one or more of the following additional elements in any combination: Element 1: wherein the controller processes the information based on a flow of the additive by constructing at least one of photo information, video information, flow rate information, and flow quality information. Element 2: wherein the controller is configured to process the information based on a flow of the additive by applying a machine learning engine to the information, the machine learning engine comprising a training engine configured to train a machine learning model and an inference engine configured to apply the machine learning model. Element 3: wherein the training engine is configured to train a machine learning model by inputting a training dataset, the training data set comprising historical flow rate activity data, comparing, to the training dataset, an output of the training engine, the output of the training engine comprising predicted flow quality data, and based on the comparing, adjusting one or more weights of the machine learning model. Element 4: wherein the predicted flow quality data comprises a flow rate classification. Element 5: wherein the historical flow rate activity data and the flow quality data comprise at least one of image information, time information, flow velocity information, flow level information, and system design information. Element 6: wherein applying the machine learning engine to the information further comprises applying one or more weights to the information based on a flow of the additive to generate additive flow data. Element 7: the system and/or method further comprising a conveyance arranged within the first flow path and operable to convey the additive from the hopper to the second flow path, wherein the controller is configured to adjust operation of at least one of the conveyance and the mixing unit. Element 8: wherein the monitoring device is arranged such that the monitoring device captures a field of view where the first flow path intersects the second flow path. Element 9: wherein the monitoring device is arranged such that the monitoring device captures a field of view coaxial with the second flow path. Element 10: wherein the monitoring device comprises a camera. Element 11: wherein the monitoring device is further configured to capture the information based on a flow of the additive in a continuous manner, in a semi-continuous manner, or in an event-based manner.

By way of non-limiting example, exemplary combinations applicable to A and B include: Element 2 with Element 3; Element 5 with Element 6; Element 6 with Element 7; Element 4 with Element 9; Element 3 with Element 11; and Element 8 with Element 10.

All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A system for blending fluids, comprising:
a hopper that contains an additive;
a first flow path extending from the hopper and operable to receive the additive from the hopper and convey the additive along a length of the first flow path;
a second flow path in fluid communication with the first flow path to receive the additive from the first flow path;
a mixing unit in fluid communication with the second flow path to receive the additive from the second flow path;
a monitoring device arranged within the second flow path and operable to capture information based on a flow of the additive within the second flow path; and
a controller electronically coupled to the monitoring device and operable to process the captured information and output the information to a console screen.

2. The monitoring system of claim 1, wherein the controller processes the information based on a flow of the additive by constructing at least one of photo information, video information, flow rate information, and flow quality information.

3. The monitoring system of claim 1, wherein the controller is configured to process the information based on a flow of the additive by applying a machine learning engine to the information, the machine learning engine comprising a training engine configured to train a machine learning model and an inference engine configured to apply the machine learning model.

4. The monitoring system of claim 3, wherein the training engine is configured to train a machine learning model by:
inputting a training dataset, the training data set comprising historical flow rate activity data;
comparing, to the training dataset, an output of the training engine, the output of the training engine comprising predicted flow quality data; and
based on the comparing, adjusting one or more weights of the machine learning model.

5. The monitoring system of claim 4, wherein the predicted flow quality data comprises a flow rate classification.

6. The monitoring system of claim 4, wherein the historical flow rate activity data and the flow quality data comprise at least one of image information, time information, flow velocity information, flow level information, and system design information.

7. The monitoring system of claim 3, wherein applying the machine learning engine to the information further comprises applying one or more weights to the information based on a flow of the additive to generate additive flow data.

8. The monitoring system of claim 1, further comprising a conveyance arranged within the first flow path and operable to convey the additive from the hopper to the second flow path, wherein the controller is configured to adjust operation of at least one of the conveyance and the mixing unit.

9. The monitoring system of claim 8, wherein the monitoring device is arranged such that the monitoring device captures a field of view where the first flow path intersects the second flow path.

10. The monitoring system of claim 8, wherein the monitoring device is arranged such that the monitoring device captures a field of view coaxial with the second flow path.

11. The monitoring system of claim 1, wherein the monitoring device comprises a camera.

12. The monitoring system of claim 1, wherein the monitoring device is further configured to capture the information based on a flow of the additive in a continuous manner, in a semi-continuous manner, or in an event-based manner.

13. A method, comprising:
feeding an additive from a hopper to a first flow path;
conveying the additive along the first flow path;
discharging the additive from the first flow path into a second flow path in fluid communication with the first flow path;
delivering the additive to a mixing unit in fluid communication with the second flow path;
capturing, via a monitoring device, information based on a flow of the additive, the monitoring device being arranged to capture the information based on the flow of the additive within the second flow path;
outputting the information to a controller electronically coupled to the monitoring device;
processing the information with the controller; and
outputting the information to a console screen.

14. The method of claim 13, wherein processing the information with the controller comprises constructing at least one of photo information, video information, flow rate information, and flow quality information.

15. The method of claim 13, wherein the controller is configured to process the information based on a flow of the additive by applying a machine learning engine to the information, the machine learning engine comprising a training engine configured to train a machine learning model and an inference engine configured to apply the machine learning model.

16. The method of claim 15, wherein the training engine trains a machine learning model by:
inputting a training dataset, the training data set comprising historical flow rate activity data;
comparing, to the training dataset, an output of the training engine, the output of the training engine comprising predicted flow quality data; and
based on the comparing, adjusting one or more weights of the machine learning model.

17. The method of claim 16, wherein the predicted flow quality data comprises a flow rate classification.

18. The method of claim 16, wherein the historical flow rate activity data and the flow quality data comprise at least one of image information, time information, flow velocity information, flow level information, and system design information.

19. The method of claim 13, wherein applying a machine learning engine to the information further comprises applying one or more weights to the information based on a flow of the additive to generate additive flow data.

20. The method of claim 13, further comprising:
conveying the additive along the first flow path from the hopper to the second flow path with a conveyance arranged within the first flow path; and
adjusting, via the controller, at least one of the conveyance and the mixing unit.
